(19) United States
(12) Patent Application Publication
(10) Pub. No.: US 2008/0121723 A1
(43) Pub. Date: May 29, 2008

(54) Portable display device and information management system

(75) Inventors: Takeshi Asai, Osaka (JP); Naoki Takahashi, Osaka (JP); Masahiro Kawasaki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/455,704

(22) Filed: Jun. 20, 2006

(30) Foreign Application Priority Data
Mar. 3, 2006 (JP) 2006-058320

(51) Int. Cl. G06K 19/06

(52) U.S. Cl. 235/492

(57) ABSTRACT

In a usual state, information concerning all stores where a user is registered as a member (a list of stores where the user is registered as a member) is listed on an electronic paper of a membership card. When the user who carries the membership card enters one store where the user is registered as a member, the membership card recognizes the entering into the store and thereby switches automatically the displayed contents on the electronic paper into information concerning that store. When the user passes through the exit of the store, the displayed contents on the electronic paper is returned to the listing display of all stores. Even a single card has the functions of a large number of cards and is valid to all the stores. This avoids the necessity that the user should carry a large number of cards.

### CROSS-REFERENCE TO RELATED APPLICATIONS

This Nonprovisional application claims priority under 35 U.S.C. §119(a) on Patent Application No. 2006-58320 filed in Japan on Mar. 3, 2006, the entire contents of which are hereby incorporated by reference.

### BACKGROUND OF THE INVENTION

The present invention relates to a portable display device carried by a user and displaying information concerning a plurality of facilities (such as stores and buildings) as well as an information management system for managing information concerning a plurality of facilities by using this portable display device.

In stores such as various kinds of retail stores where users go, a service is widely provided that a membership card is issued to each user and that point management is performed in such a manner that a purchase discount amount valid in a subsequent purchase is accumulated depending on the purchased amount by using the issued membership card. Such a membership card is issued by each store or each company. Thus, each user need always carry a plurality of membership cards issued respectively from a plurality of stores. Further, a particular membership card corresponding to the store where a user is visiting need be found from among a plurality of these membership cards. These situations have caused a problem of annoyance.

A card for solving such a problem is proposed in Japanese Patent Application Laid-Open No. 2005-284677 (referred to as the prior art example, hereinafter). In the prior art example, an identification card with face photograph is employed. Then, the image data of an identification photograph, ID information relevant to this, and ID authentication information indicating that a predetermined card issuing organization has approved the image data and the ID information are combined as a set so that a plurality of such sets are stored into a single card. Then, on occasions of necessity, the image data and the ID information of a desired set are displayed so that the single card serves as a plurality of identification cards such as an employee ID card and a driver's license for identifying the individual person.

Nevertheless, when the card described in the prior art example is applied to membership cards of retail stores, a problem arises that listing display is not achieved for a large number of stores where membership registration is completed. Thus, the user cannot check, at a glance, all stores where membership registration is completed. Accordingly, the card has difficulty in being used as membership cards of stores such as point cards.

### BRIEF SUMMARY OF THE INVENTION

The present invention has been devised in view of this situation. An object of the present invention is to provide: a portable display device in which display is switched between the display of information concerning all facilities (stores) and the display of information concerning a particular facility (store) so that even a single device (a single card) has the functions of a large number of devices (a large number of cards) and is valid to all the facilities (stores), so that the necessity is avoided that a user should carry a large number of devices (a large number of cards), so that the user's convenience is improved; and an information management system for managing information concerning a plurality of facilities using this portable display device.

The portable display device according to the present invention is a portable display device for displaying information concerning a plurality of facilities, comprising display means for switching the display and thereby displaying information concerning the entirety of the plurality of facilities and information concerning one facility among the plurality of facilities. In the portable display device of the present invention, the display is switched between display of information concerning the entirety of a plurality of facilities (stores) and display of information concerning an individual facility (store). Thus, since information concerning the entirety of a plurality of facilities (stores) is listed, the user can recognize, at a glance, information concerning all the facilities (stores) visually. This provides convenience. Further, a single portable display device (a single card) displays information concerning all the facilities (stores). Thus, the user need not carry a large number of portable display devices (a large number of cards). This provides convenience of high level to the user.

A portable display device according to the present invention comprises recognition means for recognizing whether the device is located at any one of the plurality of facilities. Then, when the recognition means has recognized that the device is located at any one of the plurality of facilities, information is displayed that is concerning the facility where the device is located. In the portable display device of the present invention, depending on the environment of use, information concerning all facilities (all stores) is displayed, or alternatively information concerning an individual facility (store) is displayed. When the device is located at a particular facility (store), information concerning the particular facility (store) is displayed. In contrast, when the device is not located at any one of the facilities (stores), information concerning all facilities (all stores) is displayed. That is, when the user enters a facility (store), the display is switched into the display of information concerning the facility (store). Further, when the user exits the facility (store), the display is switched into the display of information concerning all facilities (stores). This provides convenience of remarkably high level to the user.

A portable display device according to the present invention comprises means for receiving a switching into the display of information concerning the entirety of the plurality of facilities. In the portable display device of the present invention, when a predetermined input (button operation or the like) is received from the user, the display is switched into the display of information concerning all facilities (all stores). This allows the user to acquire information concerning all facilities (all stores) in desired timing.

In a portable display device according to the present invention, the information concerning each of the plurality of facilities is rewritable. In the portable display device of the present invention, the information concerning each facility (store) is rewritten for example when the device is located at the facility (store). This allows point management and the like to be performed easily.

In an information management system according to the present invention, the information concerning the plurality of facilities is managed using a portable display device described above. In the information management system of the present invention, a single portable display device (a single card) described above manages the information concerning all facilities (stores). This permits easy management.

According to the portable display device of the present invention, display is switched between the information concerning the entirety of all facilities (stores) and information concerning one facility (store) among the plurality of facilities (stores). Thus, by virtue of the listing display of the information concerning the entirety of the plurality of facilities (stores), the user can visually recognize at a glance the information concerning all facilities (stores). Further, by virtue that a single portable display device (a single card) displays the information concerning all facilities (stores), the user need not carry a large number of portable display devices (a large number of cards). This improves the user's convenience.

Further, according to the portable display device of the present invention, when the device has recognized to be located at a facility (store) among a plurality of facilities (stores), information concerning the facility (store) where the device is located is displayed. In contrast, when the device has recognized not to be located at any facility (store) among the plurality of facilities (stores), information concerning the entirety of the plurality of facilities (stores) is displayed. This allows optimal information to be provided to the user depending on the environment of use.

Further, according to the portable display device of the present invention, a switching into the display of information concerning the entirety of a plurality of facilities (stores) is received. This allows the user to visually recognize the information concerning all facilities (all stores) in desired timing.

Further, according to the portable display device of the present invention, the information concerning each of the plurality of facilities (stores) is rewritable. This allows, for example, point management in the store to be performed easily for each user.

Further, according to the information management system of the present invention, the information concerning all facilities (stores) is managed using such a single portable display device (a single card). This simplifies information management.

The above and further objects and features of the invention will more fully be apparent from the following detailed description with accompanying drawings.

### BRIEF DESCRIPTION OF THE SEVERAL VIEWS OF THE DRAWINGS

FIGS. 1A and 1B are plan views of a membership card (portable display device) of the present invention;

FIG. 2 is a functional block diagram of a membership card;

FIGS. 3A and 3B are diagrams showing an example of display on a membership card;

FIG. 4 is a diagram showing an example of a basic information management record;

FIG. 5 is a diagram showing an example of member management records;

FIG. 6 is a diagram showing an example of membership card image records;

FIG. 7 is a diagram showing an example of application management records;

FIG. 8 is a flow chart showing a procedure performed at the time of membership card registration;

FIG. 9 is a diagram showing a flow of processing performed at the time of initial registration of a membership card;

FIG. 10 is a diagram showing a flow of processing performed at the time of additional store registration of a membership card;

FIG. 11 is a flow chart showing a procedure performed at the time of merchandise purchase at a store;

FIG. 12 is a diagram showing a flow of processing performed when a user enters a store;

FIG. 13 is a diagram showing a flow of processing performed when a user purchases a merchandise item at a store;

FIG. 14 is a diagram showing a flow of processing performed when a user exits a store;

FIG. 15 is a diagram showing an example of display on a membership card; and

FIG. 16 is a diagram showing an example of display on a membership card.

### DETAILED DESCRIPTION OF THE INVENTION

The present invention is described below in detail with reference to the drawings illustrating an embodiment. The following embodiment is described for the case that the facilities are stores such as retail stores and that the portable display device is used as membership cards for point management issued by the stores. However, the invention is not limited to this embodiment.

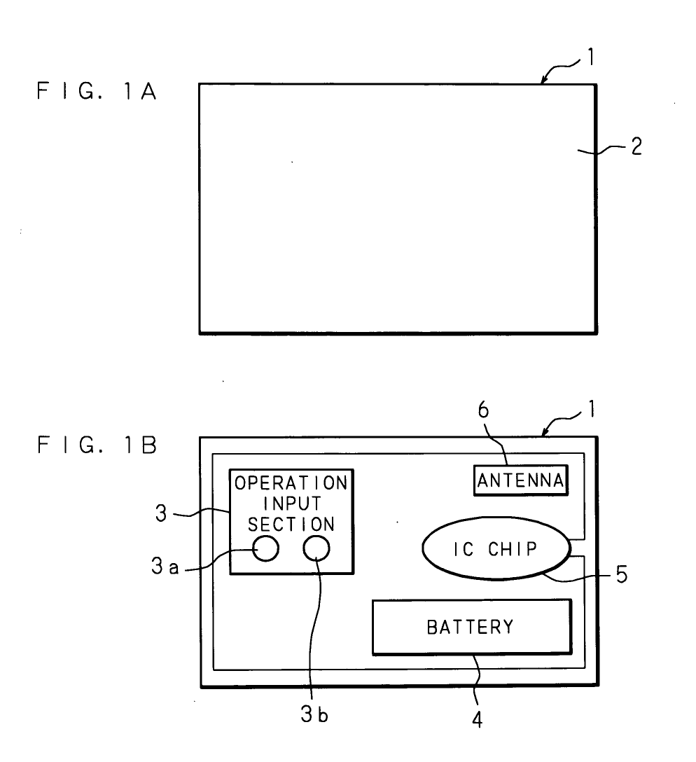

FIGS. 1A and 1B are plan views of a membership card serving as the portable display device of the present invention. FIG. 1A shows a front side, while FIG. 1B shows a back side. In the membership card 1 carried by a user, a front side of a plastic plate is provided with an electronic paper 2. A back side is provided with: an operation input section 3 for receiving a user operation; a battery 4 serving as a power supply; an IC chip 5 serving as a CPU, a memory, and the like; and an antenna 6 for wireless communication.

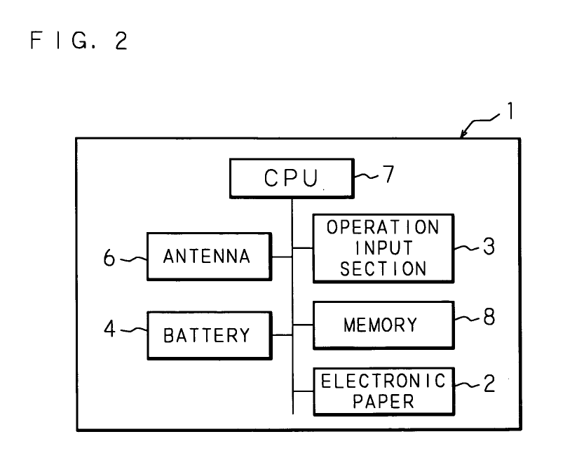

FIG. 2 is a functional block diagram of the membership card 1. The electronic paper 2 displays information concerning all stores where the user is registered as a member, or alternatively displays information concerning an individual store where the user is registered as a member. Details of the contents of these of the information concerning all stores and the information concerning each store are described later. The operation input section 3 includes: a listing display button 3a for receiving a user input for switching the display on the electronic paper 2 into the display of information concerning all stores; and an individual display button 3b for receiving a user input for switching the display on the electronic paper 2 into the display of information concerning an individual store. The battery 4 may be a solar battery or the like. The IC chip 5 comprises: a CPU 7 that performs various functions such as a display control function including the display switching of information on the electronic paper 2, an operation control function of analyzing and executing a user input operation received through the operation input section 3, and a recognition function of recognizing the store where the membership card 1 is located on the basis of a result received through the antenna 6; and a memory 8 for storing image data for display and the like.

The outline of point management is described below that is performed at a store by using the membership card 1 of the present invention having the above-mentioned configuration.

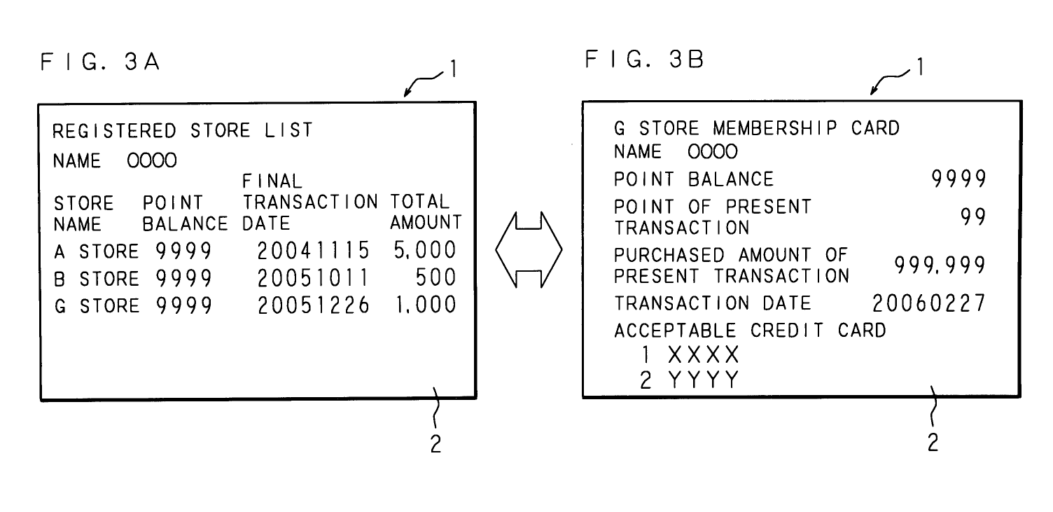

A membership card 1 is issued to a user whose membership registration has been completed. In a usual state, information concerning all stores where the user is registered as a member, that is, a list of stores where the user is registered as a member, is listed on the electronic paper 2 of the membership card 1. FIG. 3A shows a specific example of this listing display. In this example, information such as the store name, the point balance, the final transaction date, and the total amount is listed for all stores on the electronic paper 2.

Then, when the user who carries the membership card 1 enters a store where the user is registered as a member, the membership card 1 recognizes the entering into the store and thereby switches automatically the displayed contents on the electronic paper 2 into information concerning that store. At the entrance of each store a radio wave is transmitted that contains an identification code for identifying the store. Thus, the membership card 1 receives the radio wave through the antenna 6, then analyzes the radio wave, and then saves temporarily into the memory 8 the information (identification code) indicating the store where the user is located. Then, the information concerning the store is displayed on the electronic paper 2 and thereby provided to the user. FIG. 3B shows a specific example of display of information concerning an individual store. In this example, information for that store such as the point balance, the point of the present transaction, the purchased amount of the present transaction, and the acceptable credit card types is displayed on the electronic paper 2.

When the user purchases a merchandise item at the store, information in the membership card 1 (the amount of point) is updated at the time of payment at a POS system. At the same time, the displayed contents on the electronic paper 2 of the membership card 1 are also updated.

When the user having finished the shopping passes through the exit of the store, the membership card 1 recognizes the exit from the store, and thereby switches automatically the displayed contents on the electronic paper 2 into the listing display of information concerning all stores as shown in FIG. 3A. At the exit of each store a radio wave is transmitted for clearing the identification code of the store. Thus, the membership card 1 receives the radio wave through the antenna 6, and then analyzes the radio wave. Then, the identification code saved in the memory 8 is cleared, while the display is returned to the listing display that shows information concerning all stores where registration is completed.

As described above, the single membership card 1 of the present invention has the functions of a plurality of membership cards. This avoids the necessity that the user should carry a large number of membership cards, so that convenience is obtained. Further, this allows point management at a large number of stores to be performed easily. Further, the annoyance is avoided that a predetermined membership card corresponding to the store where the shopping is performed need be found from among a large number of membership cards. On the other hand, on the store side, when the store joins in such a point management system of sharing a single membership card, the necessity is avoided that a card should be issued by the store itself.

Further, in a usual state, the membership card 1 of the present invention lists the information of all stores where the user is registered as a member. Thus, the user can immediately recognize the stores where the user is registered as a member. When the user uses a store where membership registration is completed, the display is switched into the information concerning that store, so that the membership card 1 is changed automatically into the membership card for the store. When the user exits the store, the display returns automatically to the original listing display of information concerning all stores. As such, in the membership card 1 of the present invention, depending on the environment of use (the purpose of use), the displayed contents are changed automatically. This provides convenience of remarkably high level to the user who carries the card.

Basically, during the time that the user stays in the store, the information (FIG. 3B) concerning the store is displayed. However, when the user pushes the listing display button 3a, the display returns to the listing display of information concerning all stores. Thus, the function implemented by this listing display button 3a is remarkably useful for example when the user staying in a store desires to acquire the information concerning another store. Further, when the individual display button 3b is pushed, the information concerning the store is displayed again.

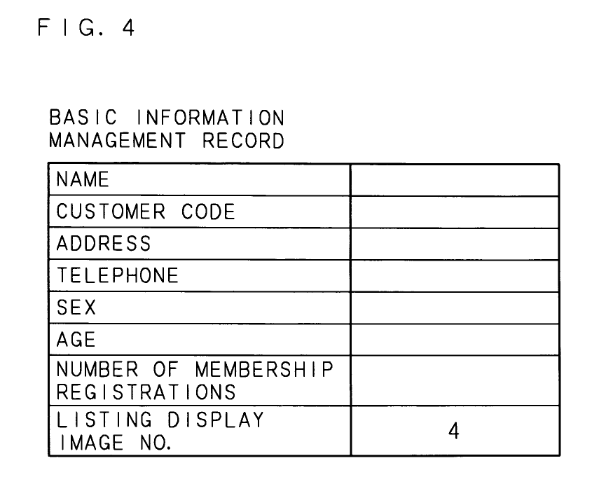

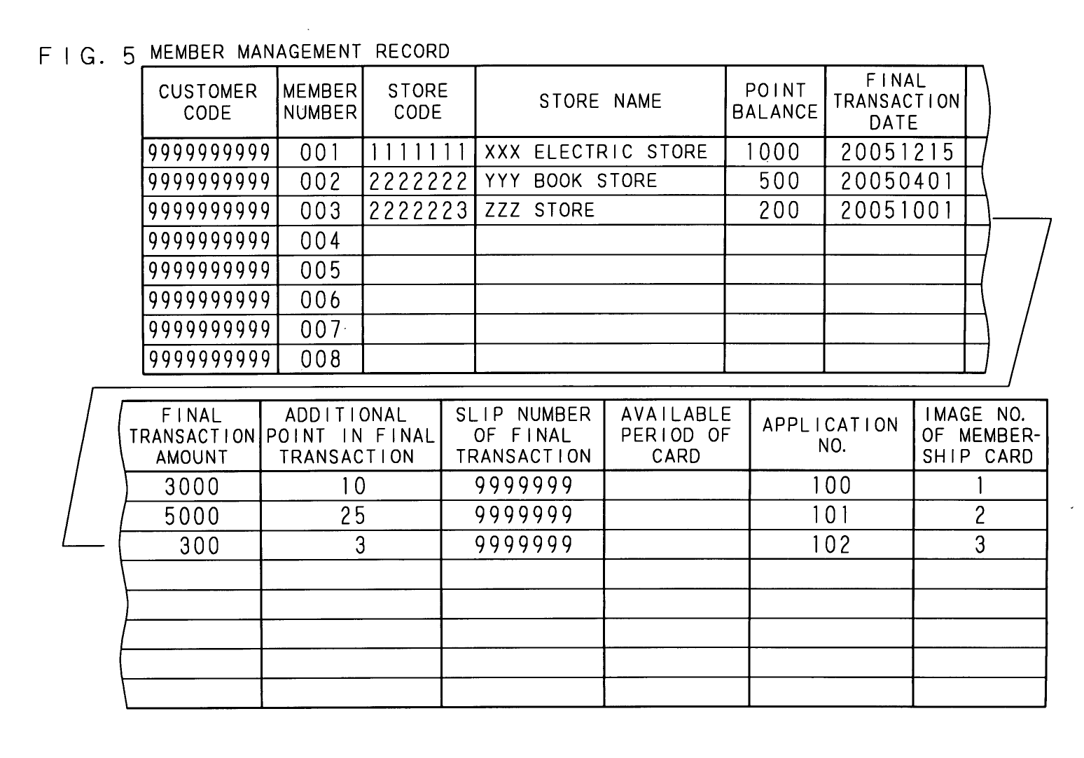

The present invention is described below in further detail. FIG. 4 is a diagram showing an example of a basic information management record of the membership card 1. Such a basic information management record is set up at the time of initial registration of the membership card 1. Further, FIG. 5 is a diagram showing an example of member management records of the membership card 1. In each member management record, initial values are set up at the time of store registration. After that, at each time of merchandise purchase at a store, the record is updated by a POS system in the store.

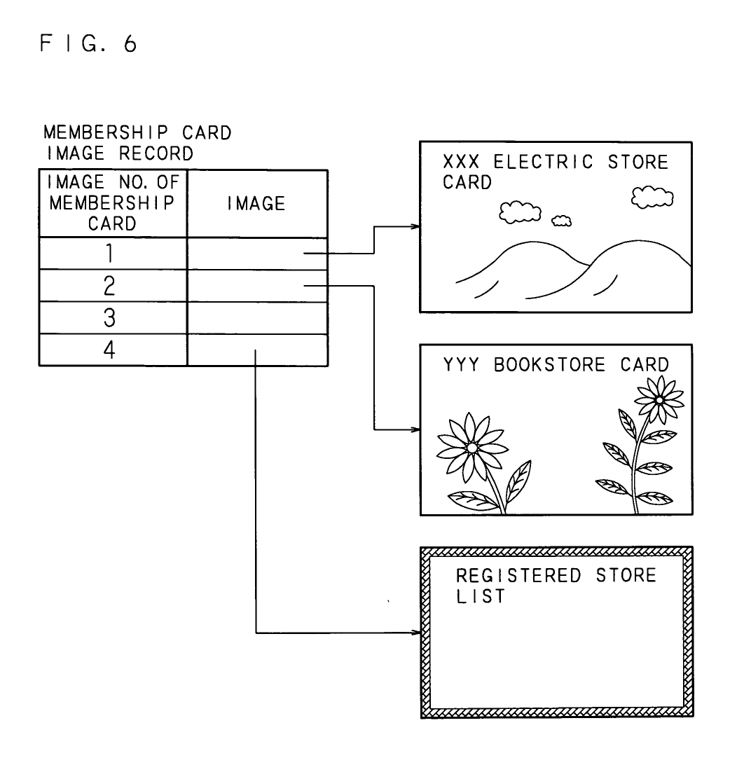

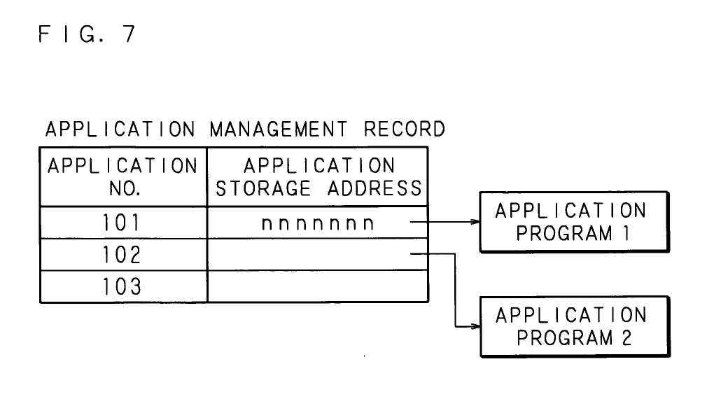

FIG. 6 is a diagram showing an example of membership card image records in the member management records. In the records, picture images for respective stores and a picture image used at the time of listing display are registered and stored. Then, one of these picture images is combined with the information shown in FIG. 3A or 3B, so that the combined image is displayed on the electronic paper 2 of the membership card 1. FIG. 7 is a diagram showing an example of application management records of the membership card 1. An application program having been set up in each store executes information management (such as point management) corresponding to the individual store for the membership card 1.

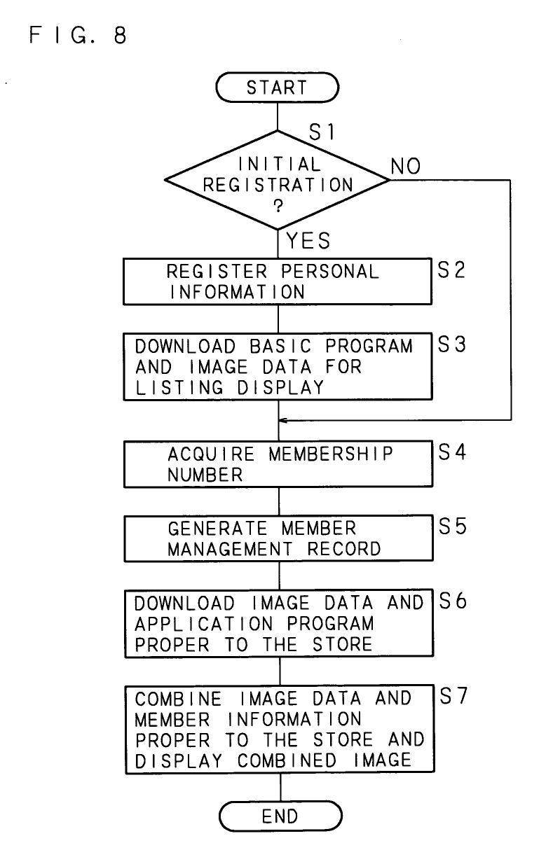

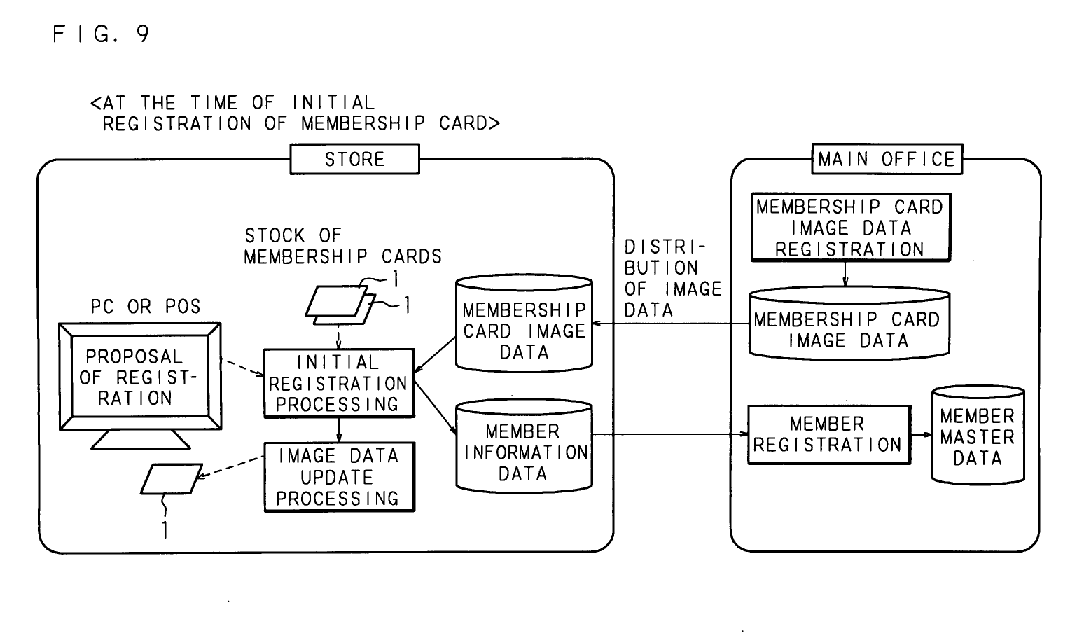

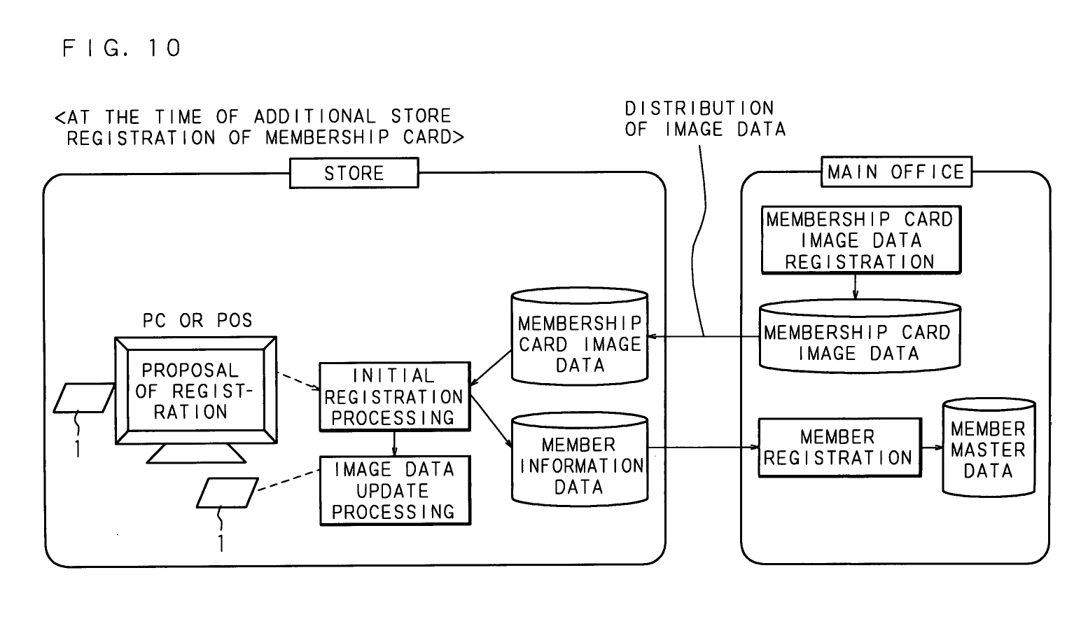

The operation of a point management system is described below that employs the membership card 1 of the present invention. Registration processing for the membership card 1 is described first. FIG. 8 is a flow chart showing a procedure performed at the time of membership card registration. FIG. 9 is a diagram showing processing performed at the time of initial registration of the membership card 1, that is, a flow of initial registration processing for a user who does not yet hold a membership card 1. FIG. 10 is a diagram showing processing performed at the time of additional store registration of the membership card 1, that is, a flow of additional registration processing for a user who holds a membership card 1 already.

When the membership card 1 is to be registered completely newly, that is, at the time of initial registration (step S1: YES), a customer code proper to the user is acquired, while personal information (basic information management record: see FIG. 4) for identifying the user is registered into the memory 8 (step S2). Then, a basic program of the membership card 1 and image data for listing display (see FIG. 6) is downloaded to the memory 8 (step S3). Thus initial registration processing is performed through a PC or a POS system at a store. The image data for listing display is distributed from the main office, while the registered personal information is stored into a master database in the main office.

On completion of the processing of S2 and S3, or alternatively when an additional store is to be registered to the membership card 1, that is, at the time of additional registration (S1: NO), a membership number for the store is acquired (step S4). Then, a member management record (see FIG. 5) is generated in the member management server at the store (step S5). Then, the POS system at the store downloads image data (see FIG. 6) and an application program (see FIG. 7) proper to the store into the memory 8 (step S6). This additional registration processing is performed through a PC or a POS system at a store. The image data proper to the store is distributed from the main office, while the registered additional store information is stored into a master database in the main office.

The image data proper to the store is combined with the member information proper to the store (such as the membership number and the point data) so that the combined image is displayed on the electronic paper 2 of the membership card 1 (step S7).

The image data update processing shown in FIG. 9 and FIG. 10 is a process of storing the common information and the store-proper information of the membership card 1 as image data into the memory 8. The point information of each store is re-imaged in a state that the point information is incorporated into the image data of the membership card 1.

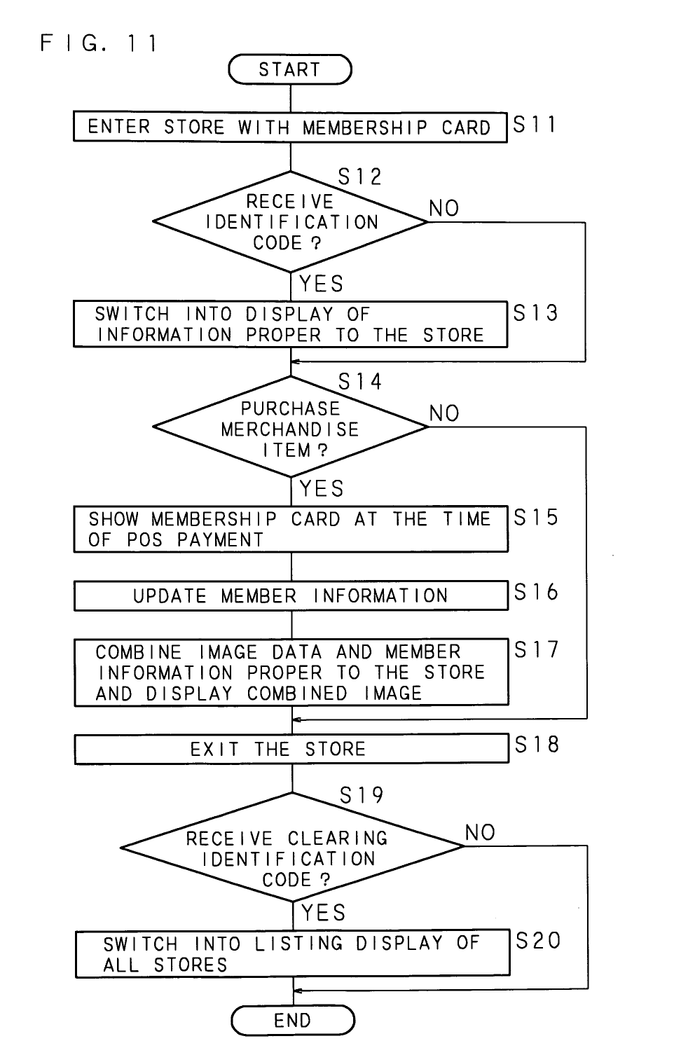

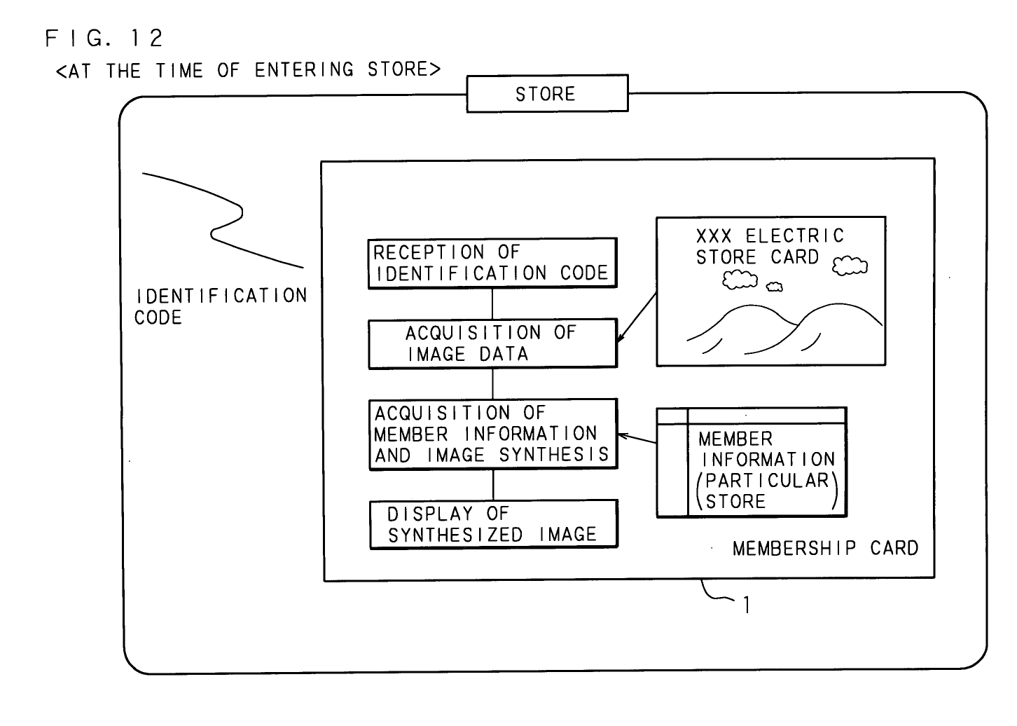

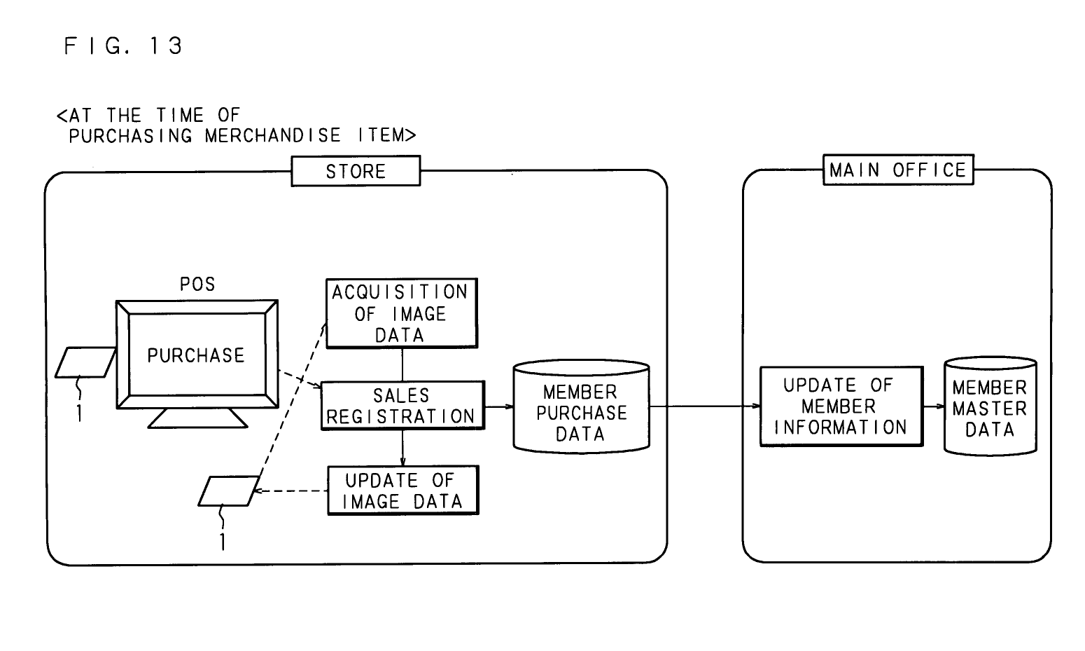

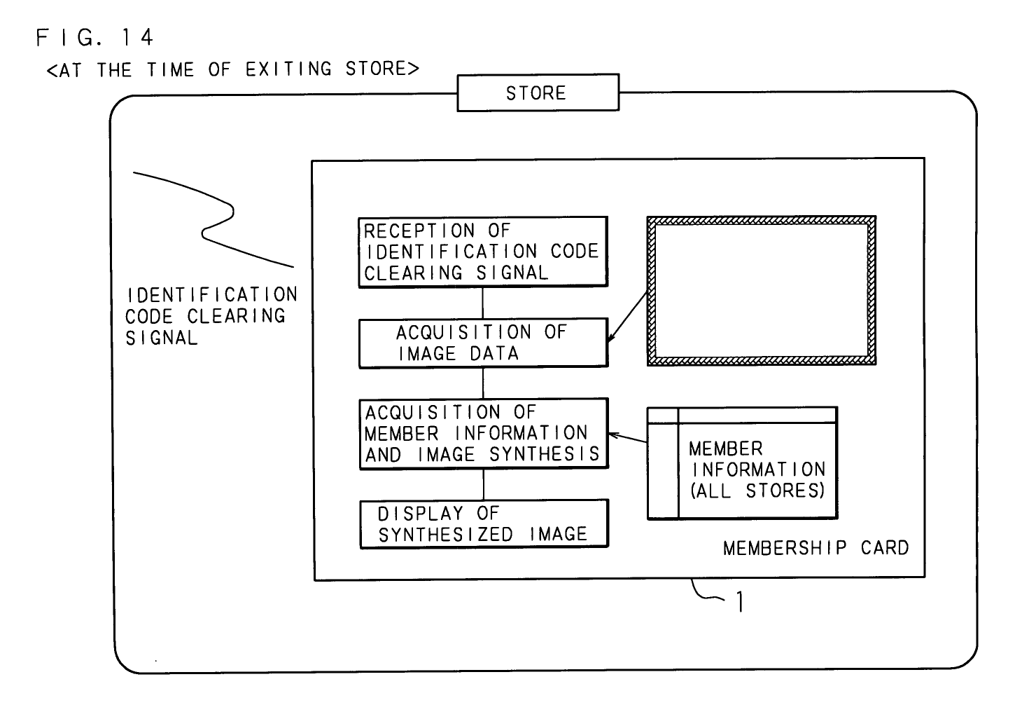

Next, the operation is described below for the case that the user who carries the registered membership card 1 goes to a store and purchases a merchandise item. FIG. 11 is a flow chart showing the procedure performed at that time. FIG. 12 is a diagram showing a flow of processing performed when the user enters a store. FIG. 13 is a diagram showing a flow of processing performed when the user purchases a merchandise item at the store. FIG. 14 is a diagram showing a flow of processing performed when the user exits the store.

With carrying the membership card 1, the user enters a store (step S11). Until the user enters the store, information concerning all stores is listed on the electronic paper 2 of the membership card 1. At the entrance of the store, when a radio wave indicating the identification code of the store is received (step S12: YES), the display on the electronic paper 2 of the membership card 1 is switched from the listing display of all stores into the display of information proper to that store (step S13). The image data of the store is combined with the member information relevant to the store, so that the combined image is displayed on the electronic paper 2. Further, the application program is also switched to that for the store. Here, when the above-mentioned radio wave is not received (S12: NO), the processing of S13 is not performed.

When the user purchases a merchandise item at the store (step S14: YES), the user shows the carried membership card 1 at the time of POS payment (step S15). At that time, the member information stored in the memory 8 of the membership card 1 is updated in accordance with the contents of purchase of this time (step S16). The member information stored in the memory 8 of the membership card 1 is read out. Then, the contents of purchase of this time is incorporated into the read-out member information, so that the member information is updated. The updated member information is stored into the memory 8. At that time, the point information is re-imaged in a state that the contents of purchase of this time is incorporated into the image data of the membership card 1. Further, the member information in the master database of the main office is also updated in accordance with the contents of purchase.

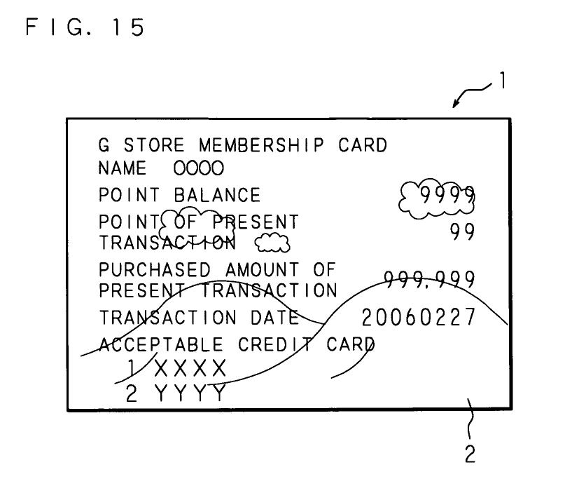

The image data proper to the store is combined with the updated member information proper to the store, so that the combined image is displayed on the electronic paper 2 of the membership card 1 (step S17). FIG. 15 shows an example of this display. Here, when the user purchases no merchandise item at the store (S14: NO), processing of S15-S17 is not performed.

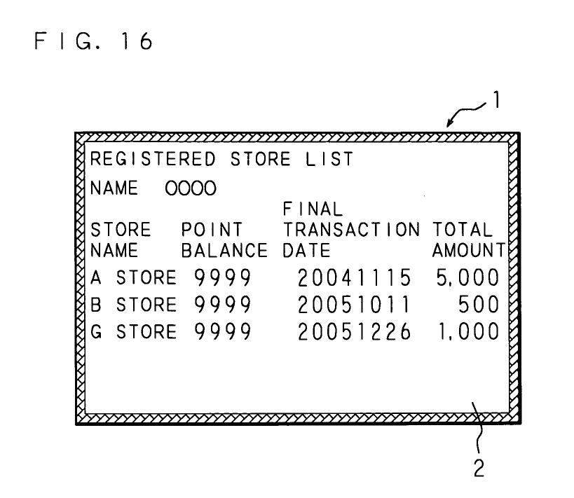

The user having finished shopping exits the store through the exit (step S18). At the exit of the store, when a radio wave for clearing the identification code of the store is received (step S19: YES), the display on the electronic paper 2 of the membership card 1 is switched from the display of information proper to that store into the listing display of all stores (step S20). The image data for listing display is combined with the information concerning all stores, so that the combined image is displayed on the electronic paper 2. FIG. 16 shows an example of this display. Here, when the above-mentioned radio wave is not received (S19: NO), the processing of S20 is not performed.

The function of combining the image data for listing display with the information concerning all stores and the function of combining the image data proper to a store with the member information proper to the store may be imparted to the membership card 1 itself or alternatively to a terminal in the store. When the function is imparted to the terminal in the store, what the membership card 1 need to perform is merely to store incorporated combined image data into the memory 8. This simplifies the internal configuration of the membership card 1.

Here, the above-mentioned embodiment has been given for the case that the entrance and the exit of the store differ from each other. However, when the entrance and the exit are shared, the radio wave containing the identification code may be transmitted from an inner side of the store, while the radio wave for clearing the identification code may be transmitted from an outer side of the store. This permits the switching of displayed contents without problems.

Further, in the embodiment described above, entering into a store and exit from the store have been recognized on the basis of radio wave communication. Alternatively, at the time of entering into the store and at the time of exit from the store, the membership card 1 may be inputted to a predetermined terminal provided in the store, so that entering into the store and exit from the store may be recognized, so that the displayed contents may be switched on the electronic paper 2.

Further, in the embodiment described above, the images have been displayed on the electronic paper 2. Alternatively, a display such as a liquid crystal panel may be provided so that the images may be displayed thereon.

Further, when the listing display button 3a was pushed, the display has been returned to the listing display. Alternatively, a timer may be provided inside the membership card 1, so that when a predetermined time has elapsed after the user entered the store, the display may be returned to the listing display. Further, the display may be returned to the listing display via a terminal in the store.

Meanwhile, the above-mentioned embodiment has been given for the case of point management employing a membership card (portable display device) at stores (facilities). However, the present invention may be modified variously in addition to the above-mentioned embodiment. For example, the facilities may be a plurality of buildings in a university, a library, a governmental or municipal office, or the like. In the use in such facilities, in a usual state, information concerning a plurality of the buildings (such as map information of all buildings) may be displayed. Then, when the user enters a particular building, display may be switched into the display of information concerning that building (such as map information of the inside of the building). Further, when the user exits the particular building, display may return to the display of information concerning a plurality of the buildings (such as map information of all buildings). Alternatively, when each floor is considered as a single facility, the present invention is similarly applicable to a condominium or an apartment house. Further, a university, a library, a governmental or municipal office, or the like may be considered as a single facility. In this case, display may be switched between the display of map information describing all these facilities and the display of map information of each facility. In yet another example, the card may serve as a student identification card when the user enters the university campus, while the card may serve as a point card when the user enters a convenience store.

Further, the portable display device of the present invention is not limited to the form of a card and may be in the form of an arbitrary device having a display function. For example, the present invention is similarly applicable to a portable telephone terminal. A portable telephone terminal incorporates a battery in the inside and has a display function and a communication function. Thus, a portable telephone terminal satisfies the requirement as the portable display device of the present invention.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A portable display device for displaying information concerning a plurality of facilities, comprising
a display section for switching the display and thereby displaying information concerning the entirety of the plurality of facilities and information concerning one facility among the plurality of facilities.

2. The portable display device according to claim 1, further comprising
a recognition section for recognizing whether the device is located at any one of the plurality of facilities, wherein
when said recognition section has recognized that the device is located at any one of the plurality of facilities, said display section displays information concerning the facility where the device is located.

3. The portable display device according to claim 2, wherein
said recognition section recognizes by wireless communication whether the device is located at any one of the plurality of facilities.

4. The portable display device according to claim 1, further comprising
a reception section for receiving a switching into the display of information concerning the entirety of the plurality of facilities.

5. The portable display device according to claim 1, wherein
the information concerning each of the plurality of facilities is rewritable.

6. The portable display device according to claim 1, wherein
the device is in a card shape.

7. The portable display device according to claim 1, wherein
the information concerning one facility among the plurality of stores contains image data for identifying the one facility.

8. The portable display device according to claim 1, further comprising
a reception section for receiving a switching into the display of information concerning the one facility.

9. The portable display device according to claim 1, wherein
the facilities are stores, while in response to entering into a store and exit from the store, said display section switches display between the display of information concerning one store among a plurality of stores and the display of information concerning the entirety of the plurality of stores.

10. An information management system, wherein
the information concerning the plurality of facilities is managed using the portable display device according to claim 1.
